(19) United States
(12) Patent Application Publication
(10) Pub. No.: US 2026/0119383 A1
(43) Pub. Date: Apr. 30, 2026

(54) MACHINE LEARNING-BASED USER INTERFACE ELEMENT PROCESSING SYSTEM

(71) Applicant: Dell Products L.P., Round Rock, TX (US)

(72) Inventors: Dev Kathuria, Greater Noida (IN); Vivek Bhargava, Bangalore (IN); Abhishek Mishra, Bangalore (IN); David C. Sydow, Merrimack, NH (US)

(21) Appl. No.: 18/930,293

(22) Filed: Oct. 29, 2024

(51) Int. Cl. G06F 11/36

(52) U.S. Cl. CPC G06F 11/3698; G06F 11/3684

(57) ABSTRACT

Methods, apparatus, and processor-readable storage media for machine learning-based user interface element processing systems are provided herein. An example computer-implemented method includes processing, into one or more data structures, data pertaining to user activity with respect to at least one web-based application user interface, and metadata pertaining to one or more user devices associated with one or more portions of the user activity; determining, by processing at least a portion of the data structure(s) using one or more machine learning techniques, one or more user activity-related commonalities across at least a portion of the data and at least a portion of the metadata; generating, based on the one or more determined user activity-related commonalities, one or more testing recommendations with respect to one or more elements of the at least one web-based application user interface; and performing one or more automated actions based on the generated testing recommendation(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

An increasing number of web-based frontend applications are being developed for an evolving number of use cases and contexts. As part of the release lifecycle of a web-based frontend application, an example task can include ensuring the quality and/or correctness of page content of the application. However, conventional application development approaches are time-intensive and require significant resources, particularly with respect to applications which contain large numbers of pages and/or elements.

### SUMMARY

Illustrative embodiments of the disclosure provide machine learning-based user interface element processing systems.

An exemplary computer-implemented method includes processing, into one or more data structures, data pertaining to user activity with respect to at least one web-based application user interface, and metadata pertaining to one or more user devices associated with one or more portions of the user activity. The method also includes determining, by processing at least a portion of the one or more data structures using one or more machine learning techniques, one or more user activity-related commonalities across at least a portion of the data pertaining to user activity and at least a portion of the metadata pertaining to the one or more user devices. Additionally, the method includes generating, based at least in part on the one or more determined user activity-related commonalities, one or more testing recommendations with respect to one or more elements of the at least one web-based application user interface, and performing one or more automated actions based at least in part on the one or more generated testing recommendations.

Illustrative embodiments can provide significant advantages relative to conventional application development approaches. For example, problems associated with time-intensive and resource-intensive techniques are overcome in one or more embodiments through generating testing recommendations for certain web-based application user interface elements using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing a machine learning-based user interface element processing system in an illustrative embodiment.

FIG. 2 shows an example table of clickstream parameters and encodings in an illustrative embodiment.

FIG. 3 shows an example table of user device metadata in an illustrative embodiment.

FIG. 4 shows example pseudocode for implementing at least a portion of a hierarchical density-based spatial clustering of applications with noise (HDBSCAN) algorithm in an illustrative embodiment.

FIG. 5 shows an example table detailing a set of labeled clusters in an illustrative embodiment.

FIG. 6 shows an example table of elements and corresponding coordinates in an illustrative embodiment.

FIG. 7 shows an example table of cluster matching to web-based application user interface elements in an illustrative embodiment.

FIG. 8 shows an example table of elements and corresponding clickstream cluster sets in an illustrative embodiment.

FIG. 9 is a flow diagram of a process for implementing a machine learning-based user interface element processing system in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

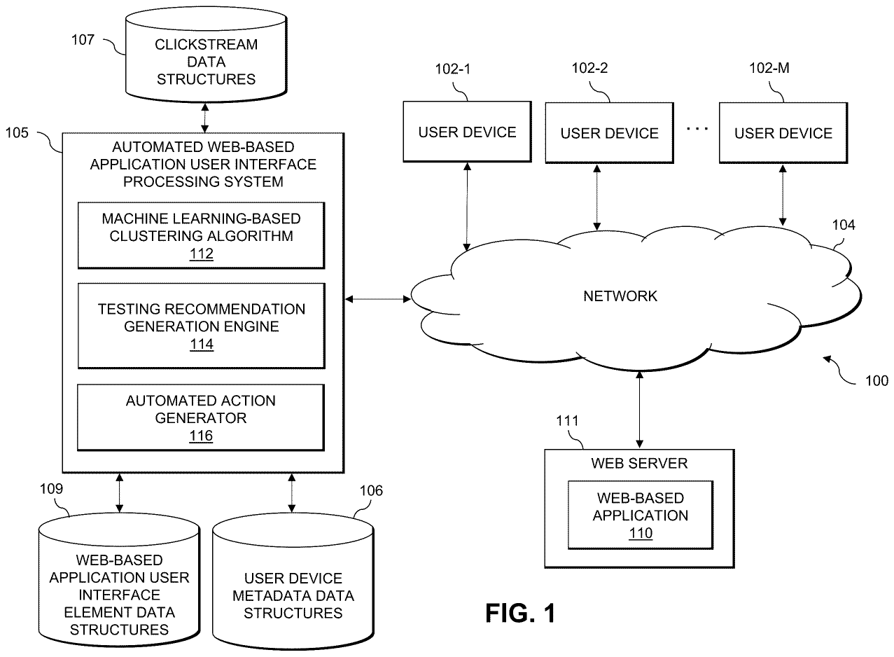

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated web-based application user interface processing system 105 and web-based application 110 running on web server 111.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated web-based application user interface processing system 105 can have one or more associated user device metadata data structures 106 configured to store metadata pertaining to user devices engaging and/or interacting with web-based application 110, such metadata including, e.g., user device IP address, session identifier (ID), click location, device type, display resolution, profile settings, etc. Also, as depicted in FIG. 1, the automated web-based application user interface processing system 105 can have one or more associated clickstream data structures 107 configured to store data pertaining to clicks, page views, page and/or application interactions, etc. Further, as additionally depicted in FIG. 1, the automated web-based application user interface processing system 105 can have one or more associated web-based application user interface element data structures 109 configured to store data pertaining to usage information, testing parameters, etc. with respect to given web-based application user interface elements. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The user device metadata data structures 106, clickstream data structures 107 and/or web-based application user interface element data structures 109 in the present embodiment are implemented using one or more storage systems associated with the automated web-based application user interface processing system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated web-based application user interface processing system 105 are one or more input-output devices, which illustratively comprise keyboards, displays or other types of input-output devices in any combination. Such input-output devices can be used, for example, to support one or more user interfaces to the automated web-based application user interface processing system 105, as well as to support communication between the automated web-based application user interface processing system 105 and other related systems and devices not explicitly shown.

Additionally, the automated web-based application user interface processing system 105 in the FIG. 1 embodiment is assumed to be implemented using at least one processing device. Each such processing device generally comprises at least one processor and an associated memory, and implements one or more functional modules for controlling certain features of the automated web-based application user interface processing system 105.

More particularly, the automated web-based application user interface processing system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated web-based application user interface processing system 105 to communicate over the network 104 with the user devices 102, and illustratively comprises one or more conventional transceivers.

The automated web-based application user interface processing system 105 further comprises machine learning-based clustering algorithm 112, testing recommendation generation engine 114, and automated action generator 116.

As further detailed herein, an example machine learning-based clustering algorithm 112 can quantify and/or categorize one or more user personas using one or more machine learning-based clustering techniques, as well as determine the breadth of unique user personas that utilize each of one or more elements of the given web-based application user interface. Additionally, an example testing recommendation generation 114 can generate, based at least in part on outputs from the machine learning-based clustering algorithm 112, recommendations pertaining to testing particular web-based application user interface elements. Further, an example automated action generator 116 can automatically initiate testing of one or more web-based application user interface elements in accordance with one or more recommendations generated by testing recommendation generation engine 114 and/or automatically output one or more recommendations generated by testing recommendation generation engine 114 to one or more testing systems and/or users associated therewith.

It is to be appreciated that this particular arrangement of elements 112, 114 and 116 illustrated in the automated web-based application user interface processing system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for implementing a machine learning-based user interface element processing system involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated web-based application user interface processing system 105, web-based application 110, user device metadata data structures 106, clickstream data structures 107 and/or web-based application user interface element data structures 109 can be on and/or part of the same processing platform.

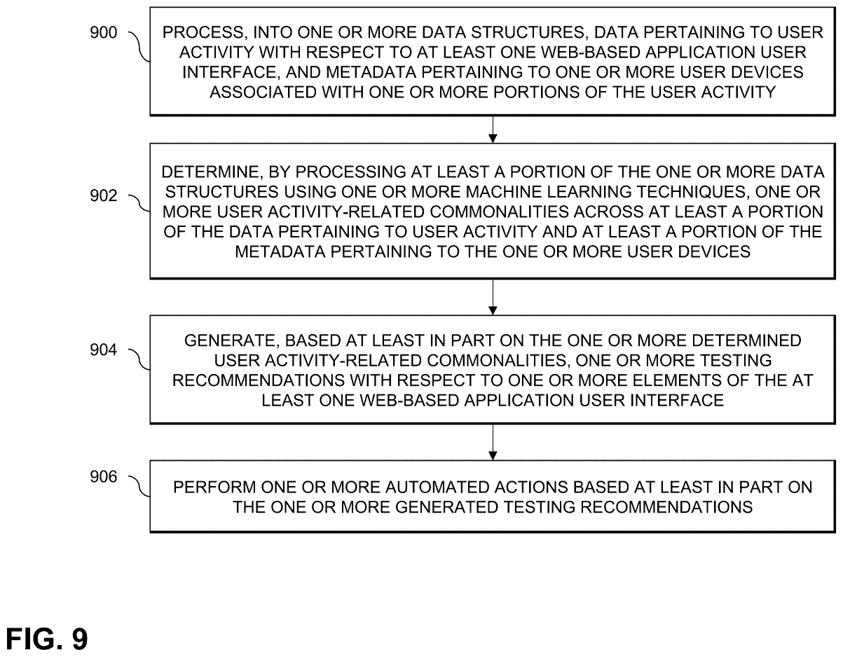

An exemplary process utilizing elements 112, 114 and 116 of an example automated web-based application user interface processing system 105 in computer network 100 will be described in more detail with reference to the flow diagram of FIG. 9.

Accordingly, at least one embodiment includes generating and/or implementing machine learning-based techniques for enhancing persona-based test case selection in one or more web-based user interfaces. As further detailed herein, such an embodiment includes collecting and evaluating user behavior for web-based frontend applications, and using the results of such evaluations to generate and/or provide one or more testing recommendations (e.g., automatically outputting one or more testing recommendations to at least one automated testing system, at least one development support team, etc.).

For a given web-based application user interface, testing-related tasks can include analyzing and validating the user interface design and/or layout, as well as validating one or more user interface components and/or elements (e.g., labels, dropdowns, radio buttons, input fields, clicks and redirections on hyperlink, etc.). Additionally, in certain contexts such as, e.g., application lifecycles following agile methodology, web-based applications can undergo frequent modifications and/or enhancements, which can result in significant code changes that must be tested. Further, many web-based applications which contain layered user interfaces can have numerous (e.g., thousands) user interface elements that can require testing against one or more specific user behavior patterns.

Accordingly, at least one embodiment includes implementing machine learning-based techniques for identifying and rating user interface elements in web-based application user interfaces, and using such ratings to generate and/or initiate application testing actions. Such an embodiment can include utilizing user clickstream data associated with the given web-based application user interfaces (e.g., data pertaining to user activity with respect to the given web-based application user interfaces, such activity including clicks, page views, page and/or application interactions, etc.), and grouping at least a portion of the user clickstream data into multiple user persona-based categories.

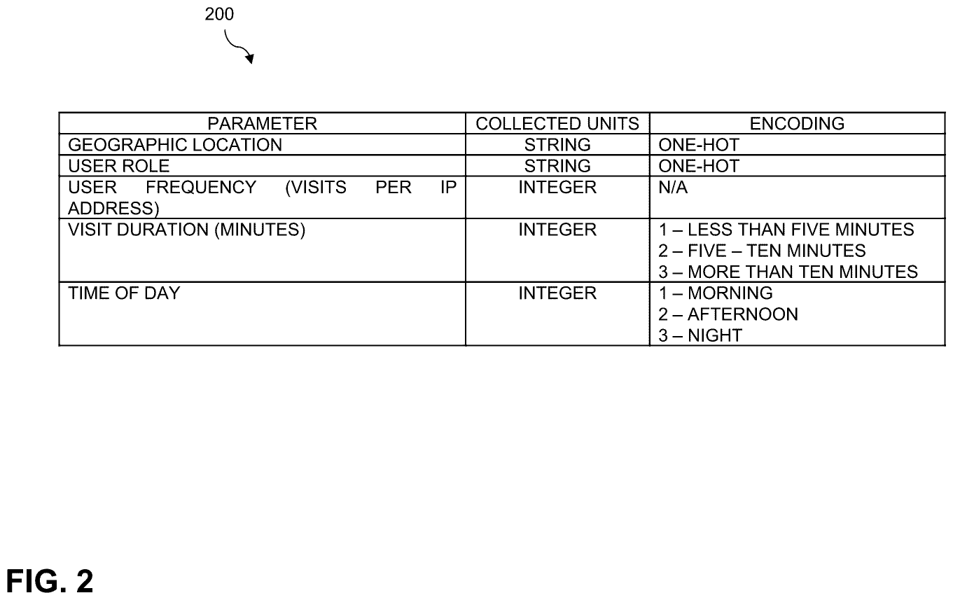

In one or more embodiments, user activity data can be collected and/or processed via at least one clickstream application embedded into the given web-based application and/or related website. Various clickstream parameters can be collected and stored into one or more data structures (e.g., clickstream data structures 107 in the FIG. 1 example embodiment). Selection and/or determination of the specific clickstream parameters can vary and can be based at least in part on the use case and/or one or more user preferences and/or system requirements. In at least one embodiment, clickstream parameter data can be collected in groups of a predetermined number of clicks (e.g., 100,000 clicks) and encoded based on at least one designated format such as, e.g., the example table depicted in FIG. 2.

FIG. 2 shows an example table 200 of clickstream parameters and encodings in an illustrative embodiment. By way merely of example, clickstream parameters can include geographic location (of the user), user role, user activity frequency (e.g., visits to the application user interface per IP address), visit duration, time of day for user activity, etc. Note that the visit duration parameter can be encoded, e.g., in units of minutes, and the time of day parameter can be encoded to one of multiple pre-designated values. As further detailed herein, in one or more embodiments, a correspondence between in the visit duration parameter and the time of day parameter can bias at least one clustering algorithm towards weighting these values more heavily due to a large distribution. Additionally, such a correspondence can also impact the definition of the epsilon value in at least one HDBSCAN algorithm, as further detailed herein.

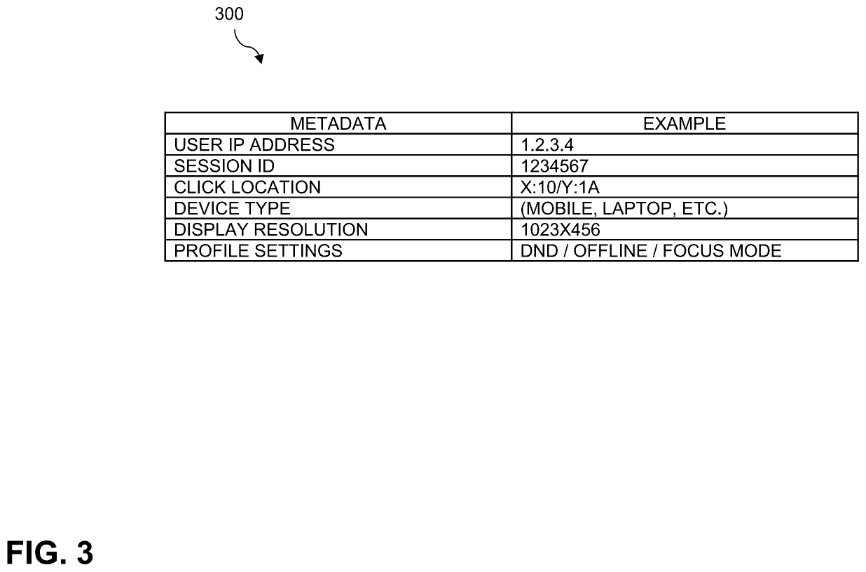

FIG. 3 shows an example table 300 of user device metadata in an illustrative embodiment. In addition to clickstream data, at least one embodiment includes collecting and/or processing metadata for one or more user devices associated with user activity in connection with the web-based application user interfaces (e.g., metadata for each click), as shown in the example table depicted in FIG. 3. Such metadata can include, for example, user device IP address, session ID, click location, device type, display resolution, profile settings, etc., and such metadata can be used, e.g., to enhance at least one classification algorithm.

Once clickstream data and device metadata have been collected and/or processed, one or more embodiments include searching across at least a portion of the clickstream data and metadata for activity-related commonalities. For example, such an embodiment can include searching for clicks (e.g., in the clickstream data) associated with the same IP address and unique session IDs (e.g., in the metadata). Additionally, in such an embodiment, the user frequency value can be adjusted to reflect the total number of unique visits to the application and/or related website, based on above-noted determination(s) involving the same IP address with unique session IDs. By way of example, two clicks associated with a user IP address of 1.2.3.4, both having a session ID of 123 will count as a user frequency value of one, while two clicks associated with a user IP address of 1.2.3.4, one having a session ID of 123, and one having a session ID of 456, will count as a user frequency value of two.

In addition to and/or conjunction with such processing detailed above, one or more embodiments include quantifying one or more user personas (also referred to herein as user persona categories) using one or more machine learning-based clustering techniques. Such techniques can include determining and/or understanding the breadth of unique user personas that utilize each of one or more elements of the given web-based application user interface. In at least one embodiment, an assumption can be made that user interface elements utilized by a sufficiently large breadth of user personas are to be tested more extensively, as each unique persona may have a potentially different use case.

One or more embodiments can include generating at least one unique set of user personas using the HDBSCAN clustering algorithm with at least a portion of the encoded clickstream parameters detailed above (e.g., in connection with FIG. 2).

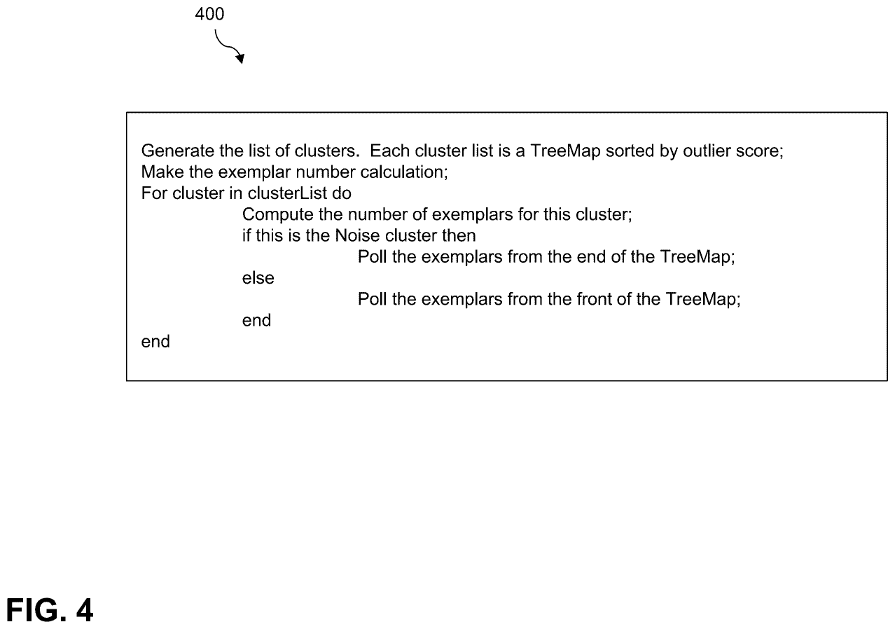

FIG. 4 shows example pseudocode for implementing at least a portion of an HDBSCAN clustering algorithm in an illustrative embodiment. In this embodiment, example pseudocode 400 is executed by or under the control of at least one processing system and/or device. For example, the example pseudocode 400 may be viewed as comprising a portion of a software implementation of at least part of automated web-based application user interface processing system 105 of the FIG. 1 embodiment.

The example pseudocode 400 illustrates generating the list of clusters, wherein each cluster list is a tree map sorted by outlier score. Additionally, example pseudocode 400 illustrates performing the exemplar number calculation, and for each cluster in cluster list, computing the number of exemplars for this cluster. If this cluster is the noise cluster, then the exemplars from the end of the tree map are polled. Otherwise, the exemplars from the front of the tree map are polled.

It is to be appreciated that this particular example pseudocode shows just one example implementation of at least a portion of an HDBSCAN clustering algorithm, and alternative implementations can be used in other embodiments.

Implementing the HDBSCAN clustering algorithm can include automatically selecting the total number of unique clusters for the given data. By way of example, a minimum points parameter for the HDBSCAN clustering algorithm can be set at three, indicating that any cluster should contain at least three unique data points. The epsilon value, used for determining distribution within each cluster for the HDBSCAN clustering algorithm, can be determined, in at least one example embodiment, using values pertaining to the maximum distance (Max) between two data points while still belonging to the same cluster, and values pertaining to the minimum number of data points (Min) to be included in a cluster (e.g., a time of day cluster, a user role cluster, a visit time cluster, a user geographic location cluster, etc.), such as illustrated in Equation (1) as follows:

$$\sqrt{{( Time Of {Day}_{Max} - Time Of {Day}_{Min} )}^{2} + {( {Role}_{Max} - {Role}_{Min} )}^{2} + {( Visit {Time}_{Max} - Visit {Time}_{Min} )}^{2} {( G e {o}_{Max} - G e {o}_{Min} )}^{2}} \qquad ( 1 )$$

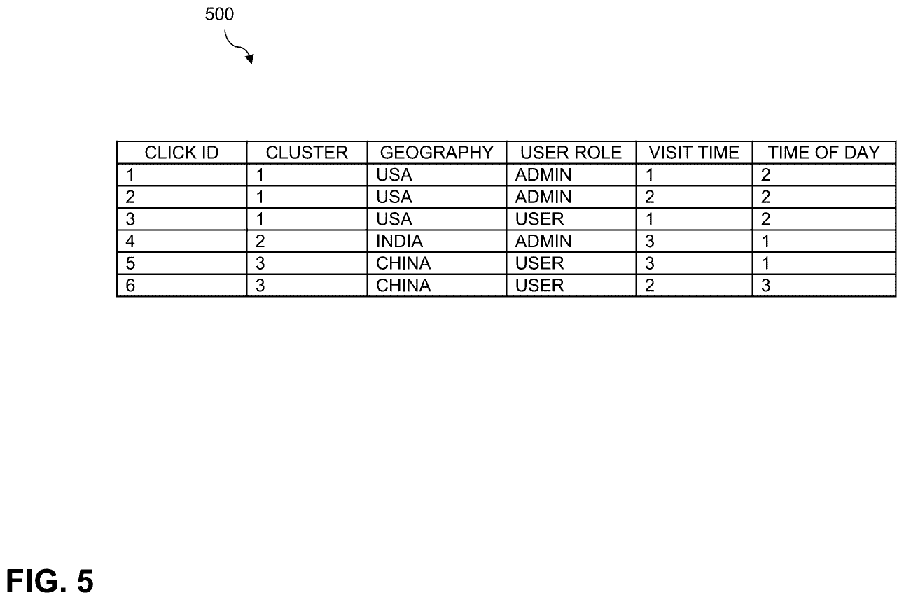

The output of the HDBSCAN clustering algorithm can include a set of labeled clusters, as shown in the example table depicted in FIG. 5.

FIG. 5 shows example table 500 detailing a set of labeled clusters in an illustrative embodiment. By way of illustration, table 500 depicts a column of clickstream data IDs (click ID), a column of cluster information associated therewith, a column of geographic information associated therewith, a column of user role associated therewith, a column of visit time information associated therewith, and a column of time of day information associated therewith.

As detailed above and further herein, the distribution of data in the clusters will be determined using the HDBSCAN clustering algorithm.

Additionally, one or more embodiments include associating one or more clusters with one or more user interface elements. By way of example, in such an embodiment, each data point in a given cluster can be associated with an item of user activity data (e.g., a click, a hover location on the web-based application user interface, etc.), and each such item of user activity data can be associated with a specific element in the web-based application user interface. Such associations can be determined, e.g., using at least a portion of the clickstream data, which can indicate behavior and associations of various elements.

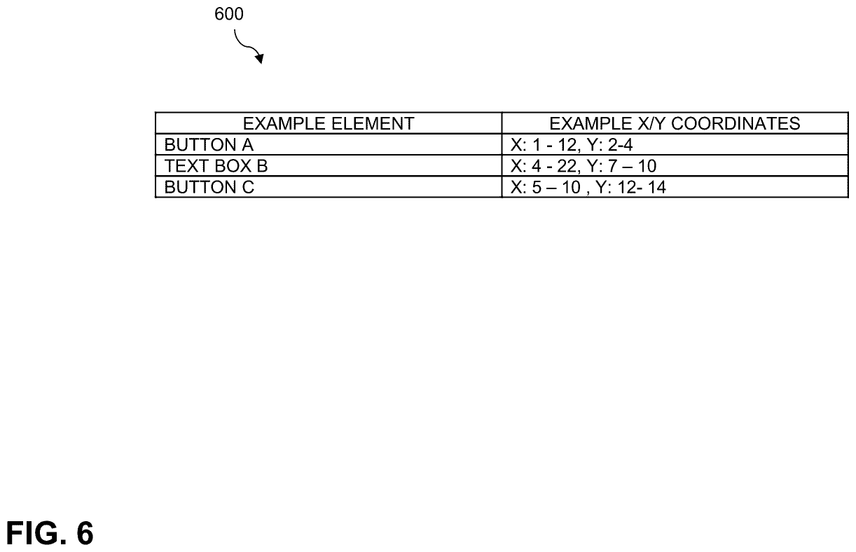

An example set of web-based application user interface elements and their associated coordinates can be seen in the example table depicted in FIG. 6. As used herein, coordinates refer to the position of an element on a web page. This position can be defined, e.g., by two values: the x-coordinate and the y-coordinate. In at least one embodiment, the x-axis represents the horizontal axis in such a coordinate system, and the y-axis represents the vertical axis in the coordinate system. When positioning a web element, the x-coordinate determines how far the element is from the left edge of the web page, and a higher x-coordinate value indicates that the element is positioned farther to the right. The y-coordinate determines how far the element is from the top edge of the web page, and a higher y-coordinate value indicates that the element is positioned farther down the page.

FIG. 6 shows an example table 600 of elements and corresponding coordinates in an illustrative embodiment. By way of illustration, table 600 depicts web-based application user interface elements including “Button A,” “Text Box B,” and “Button C,” and also depicts a column of example coordinates corresponding to those elements.

In such an embodiment, the coordinates can be relative, e.g., to device type, resolution, and form factor, as outlined in the table depicted in FIG. 3. However, for simplicity of this example, it is assumed that the web-based application user interface elements are all of a single form factor, device type, and resolution.

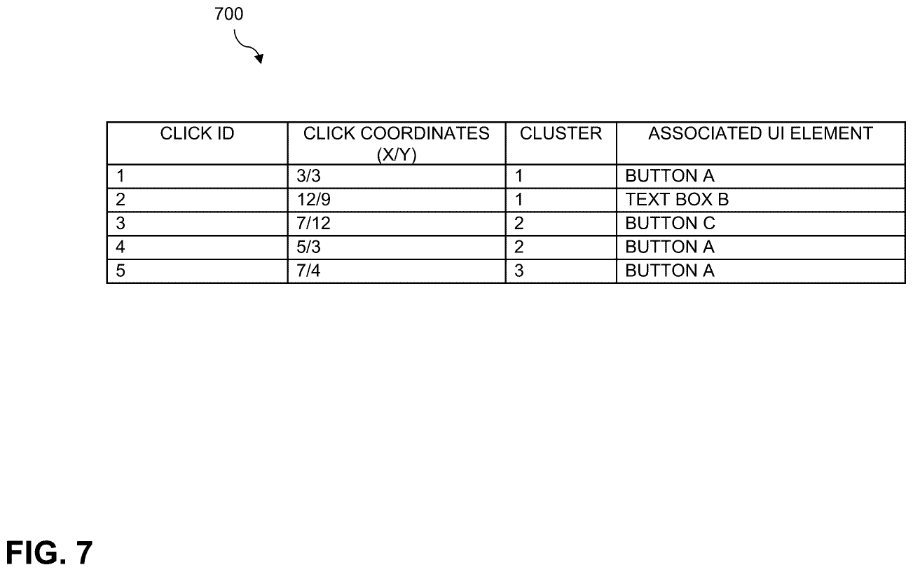

In one or more embodiments, for every element in the web-based application user interface, a search can be performed on each data point in the given dataset to determine if there are matching coordinates in one or more of the data points. If there are matching coordinates in one or more data points, the associated cluster(s) with the data point(s) can be stored in at least one data structure (e.g., in web-based application user interface element data structures 109 in the FIG. 1 example embodiment) associated with the given web-based application user interface element. An example of clickstream data matched to one or more web-based application user interface elements is shown in the table depicted in FIG. 7.

FIG. 7 shows an example table 700 of cluster matching to web-based application user interface elements in an illustrative embodiment. By way of illustration, table 700 depicts a column of clickstream data IDs (click ID), a column of clickstream coordinates associated therewith (click coordinates), a column of cluster information associated therewith, and a column of user interface element associated therewith.

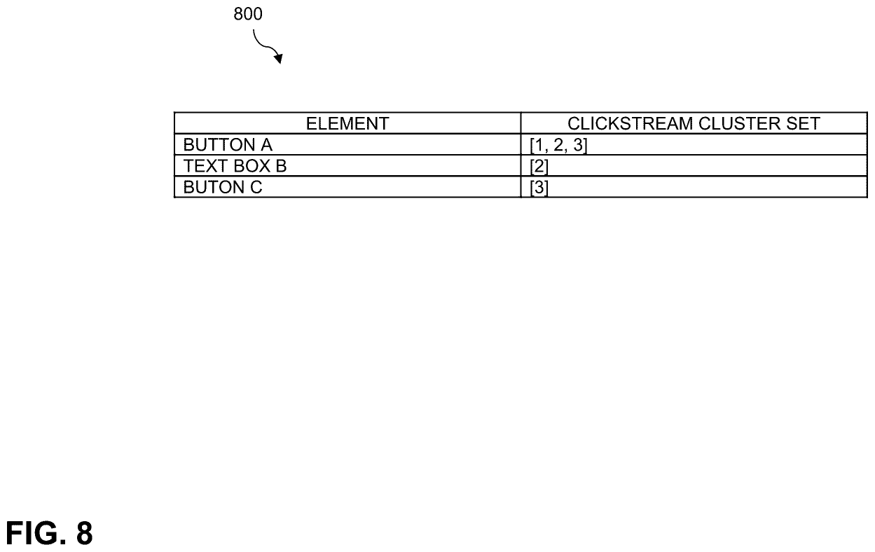

Subsequent to the above-noted process, a list of one or more web-based application user interface elements, with each element having a set of unique clickstream clusters associated therewith, can be generated such as shown in the example table depicted in FIG. 8.

FIG. 8 shows an example table 800 of elements and corresponding clickstream cluster sets in an illustrative embodiment. By way of illustration, table 800 depicts web-based application user interface elements including “Button A,” “Text Box B,” and “Button C,” and also depicts a column of example clickstream cluster sets corresponding to those elements.

After at least a portion of the one or more web-based application user interface elements (e.g., all of the one or more web-based application user interface elements) have been associated with a clickstream cluster set, each such element can be evaluated with a score (e.g., high, medium, or low). In one or more embodiments, such a score can be used to indicate the level of testing required for the given one or more web-based application user interface element. As noted, in at least one embodiment, an assumption made by scoring algorithm is that one or more web-based application user interface elements with a sufficiently large clickstream cluster set are used by a diverse set of personas and should receive more in-depth testing.

In one or more embodiments, generating a score for a given one or more web-based application user interface elements can be carried out by determining relative cluster weights, determining element distribution weights, and generating one or more recommendations based at least in part on the relative cluster weights and the element distribution weights.

With respect to determining relative cluster weights each cluster can receive and/or be associated with a cluster weight, determined by the total number of data points in the cluster. In at least one embodiment, clusters with a significant number of data points (e.g., a number of data points exceeding a given threshold) will represent a large amount of overall clicks, and clusters with lower numbers of data points (e.g., a number of data points below a given threshold) will represent a small amount of overall clicks. More particularly, in such an embodiment, determining a relative cluster weight can be carried out via Equation (2) as follows:

$$Cluster {Weight}_{cluster\_i} = \frac{Total Clicks in {Cluster}_{cluster\_i}}{Total Clicks in Entire Dataset} \qquad ( 2 )$$

Additionally, determining element distribution weights can be based at least in part on the relative number of unique clusters associated with each element in the web-based application user interface, which represents the number of unique types of users and/or use cases that are using a specific element in the web-based application user interface. In at least one embodiment, determining element distribution weights can be carried out via Equation (3) as follows:

$$Element {Weight}_{element\_i} = \frac{Number Of {Clusters}_{element\_i}}{N umber Of Clusters in Entire Dataset} \qquad ( 3 )$$

With respect to generating one or more recommendations, a recommendation for if a specific element should be tested can be based at least in part on a combination of the corresponding relative cluster weight, representing the total number of clicks on an element, and the corresponding element distribution weight, representing the number of unique configurations and users utilizing the UI element. In one or more embodiments, recommendations can be generated on the basis of high impact, medium impact, and low impact.

By way of example, a high impact recommendation can be generated when the cluster weight for any cluster element in the given element set is greater than two standard deviations from the mean cluster weight, and the element weight for this element is greater than two standard deviations from the mean. Further, a low impact recommendation can be generated when the cluster weight for any cluster in the given element cluster set is less than one standard deviation from the mean cluster weight, and the element weight for this element is less than two standard deviations from the mean. Additionally, a medium impact recommendation can be generated when the given element does not fall under the low impact recommendation category or the high impact recommendation category.

Accordingly, as detailed herein, one or more embodiments include using specific data sources, encodings, and algorithms to generate persona-based clusters, and generate cluster-based weighted recommendations for the testing of web-based application user interface elements.

FIG. 9 is a flow diagram of a process for implementing a machine learning-based user interface element processing system in an illustrative embodiment. It is to be understood that this particular process is only an example, and additional or alternative processes can be carried out in other embodiments.

In this embodiment, the process includes steps 900 through 906. These steps are assumed to be performed by the automated web-based application user interface processing system 105 utilizing elements 112, 114 and 116.

Step 900 includes processing, into one or more data structures, data pertaining to user activity with respect to at least one web-based application user interface, and metadata pertaining to one or more user devices associated with one or more portions of the user activity. In at least one embodiment, the data pertaining to user activity can include clickstream data comprising information related to one or more of click location, page views, page interactions, user geographic location, user role, user activity frequency, visit duration, and time of day for user activity. Also, in at least one embodiment, the metadata can include information related to one or more of internet protocol addresses, session identifiers, click locations, device type, display resolution, and device settings.

Step 902 includes determining, by processing at least a portion of the one or more data structures using one or more machine learning techniques, one or more user activity-related commonalities across at least a portion of the data pertaining to user activity and at least a portion of the metadata pertaining to the one or more user devices. In one or more embodiments, determining one or more user activity-related commonalities includes generating multiple user activity-related categories by processing the at least a portion of the one or more data structures using at least one HDBSCAN clustering algorithm. In such an embodiment, generating multiple user activity-related categories can include determining, within each of the multiple user activity-related categories, a breadth of unique users that utilize each of the one or more elements of the at least one web-based application user interface.

Step 904 includes generating, based at least in part on the one or more determined user activity-related commonalities, one or more testing recommendations with respect to one or more elements of the at least one web-based application user interface. In at least one embodiment, generating one or more testing recommendations includes assigning a score to each of the one or more elements of the at least one web-based application user interface based at least in part on the determined breadth of unique users utilizing the element across at least a portion of the multiple user activity-related categories. In such an embodiment, generating one or more testing recommendations can include recommending a level of testing required for the one or more elements of the at least one web-based application user interface based at least in part on the assigned scores.

Step 906 includes performing one or more automated actions based at least in part on the one or more generated testing recommendations. In one or more embodiments, performing one or more automated actions includes automatically initiating performance of testing at least a portion of the one or more elements of the at least one web-based application user interface in accordance with the one or more generated testing recommendations. Additionally or alternatively, performing one or more automated actions can include automatically training at least a portion of the one or more machine learning techniques based at least in part on feedback related to the one or more generated testing recommendations.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to generate testing recommendations for certain web-based application user interface elements using machine learning techniques. These and other embodiments can effectively overcome problems associated with time-intensive and resource-intensive conventional techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

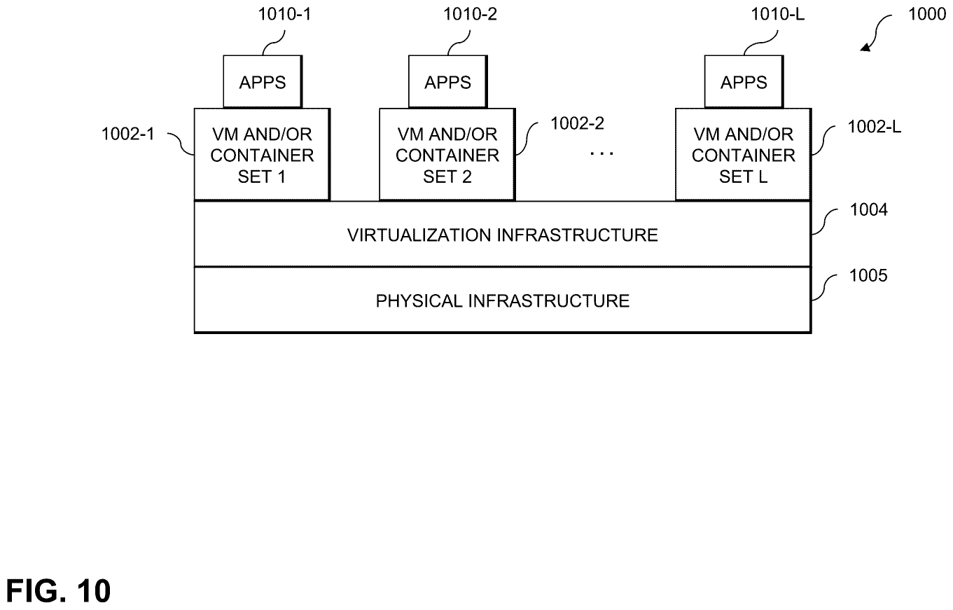

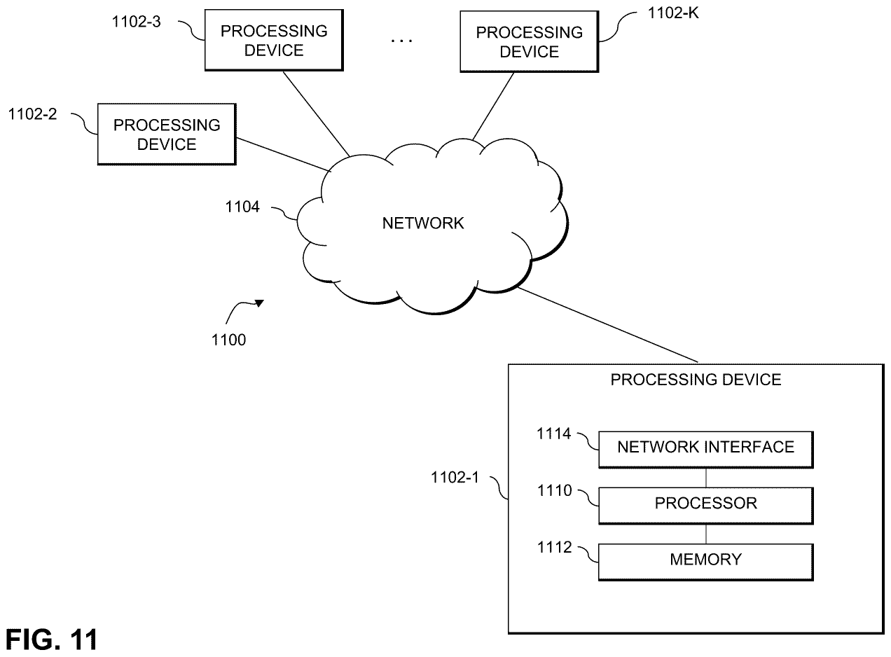

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . , 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more information processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 1112 comprises RAM, ROM or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing, into one or more data structures, data pertaining to user activity with respect to at least one web-based application user interface, and metadata pertaining to one or more user devices associated with one or more portions of the user activity;
determining, by processing at least a portion of the one or more data structures using one or more machine learning techniques, one or more user activity-related commonalities across at least a portion of the data pertaining to user activity and at least a portion of the metadata pertaining to the one or more user devices;
generating, based at least in part on the one or more determined user activity-related commonalities, one or more testing recommendations with respect to one or more elements of the at least one web-based application user interface; and
performing one or more automated actions based at least in part on the one or more generated testing recommendations;
wherein the method is performed by at least one processing device comprising a processor coupled to a memory.

2. The computer-implemented method of claim 1, wherein performing one or more automated actions comprises automatically initiating performance of testing at least a portion of the one or more elements of the at least one web-based application user interface in accordance with the one or more generated testing recommendations.

3. The computer-implemented method of claim 1, wherein determining one or more user activity-related commonalities comprises generating multiple user activity-related categories by processing the at least a portion of the one or more data structures using at least one hierarchical density-based spatial clustering of applications with noise (HDBSCAN) clustering algorithm.

4. The computer-implemented method of claim 3, wherein generating multiple user activity-related categories comprises determining, within each of the multiple user activity-related categories, a breadth of unique users that utilize each of the one or more elements of the at least one web-based application user interface.

5. The computer-implemented method of claim 4, wherein generating one or more testing recommendations comprises assigning a score to each of the one or more elements of the at least one web-based application user interface based at least in part on the determined breadth of unique users utilizing the element across at least a portion of the multiple user activity-related categories.

6. The computer-implemented method of claim 5, wherein generating one or more testing recommendations comprises recommending a level of testing required for the one or more elements of the at least one web-based application user interface based at least in part on the assigned scores.

7. The computer-implemented method of claim 1, wherein performing one or more automated actions comprises automatically training at least a portion of the one or more machine learning techniques based at least in part on feedback related to the one or more generated testing recommendations.

8. The computer-implemented method of claim 1, wherein the data pertaining to user activity comprises clickstream data comprising information related to one or more of click location, page views, page interactions, user geographic location, user role, user activity frequency, visit duration, and time of day for user activity.

9. The computer-implemented method of claim 1, wherein the metadata comprises information related to one or more of internet protocol addresses, session identifiers, click locations, device type, display resolution, and device settings.

10. A non-transitory processor-readable storage medium having stored therein program code of one or more software programs, wherein the program code when executed by at least one processing device causes the at least one processing device:
to process, into one or more data structures, data pertaining to user activity with respect to at least one web-based application user interface, and metadata pertaining to one or more user devices associated with one or more portions of the user activity;
to determine, by processing at least a portion of the one or more data structures using one or more machine learning techniques, one or more user activity-related commonalities across at least a portion of the data pertaining to user activity and at least a portion of the metadata pertaining to the one or more user devices;
to generate, based at least in part on the one or more determined user activity-related commonalities, one or more testing recommendations with respect to one or more elements of the at least one web-based application user interface; and
to perform one or more automated actions based at least in part on the one or more generated testing recommendations.

11. The non-transitory processor-readable storage medium of claim 10, wherein performing one or more automated actions comprises automatically initiating performance of testing at least a portion of the one or more elements of the at least one web-based application user interface in accordance with the one or more generated testing recommendations.

12. The non-transitory processor-readable storage medium of claim 10, wherein determining one or more user activity-related commonalities comprises generating multiple user activity-related categories by processing the at least a portion of the one or more data structures using at least one hierarchical density-based spatial clustering of applications with noise (HDBSCAN) clustering algorithm.

13. The non-transitory processor-readable storage medium of claim 12, wherein generating multiple user activity-related categories comprises determining, within each of the multiple user activity-related categories, a breadth of unique users that utilize each of the one or more elements of the at least one web-based application user interface.

14. The non-transitory processor-readable storage medium of claim 13, wherein generating one or more testing recommendations comprises assigning a score to each of the one or more elements of the at least one web-based application user interface based at least in part on the determined breadth of unique users utilizing the element across at least a portion of the multiple user activity-related categories.

15. The non-transitory processor-readable storage medium of claim 10, wherein performing one or more automated actions comprises automatically training at least a portion of the one or more machine learning techniques based at least in part on feedback related to the one or more generated testing recommendations.

16. An apparatus comprising:
at least one processing device comprising a processor coupled to a memory;
the at least one processing device being configured:
to process, into one or more data structures, data pertaining to user activity with respect to at least one web-based application user interface, and metadata pertaining to one or more user devices associated with one or more portions of the user activity;
to determine, by processing at least a portion of the one or more data structures using one or more machine learning techniques, one or more user activity-related commonalities across at least a portion of the data pertaining to user activity and at least a portion of the metadata pertaining to the one or more user devices;
to generate, based at least in part on the one or more determined user activity-related commonalities, one or more testing recommendations with respect to one or more elements of the at least one web-based application user interface; and
to perform one or more automated actions based at least in part on the one or more generated testing recommendations.

17. The apparatus of claim 16, wherein performing one or more automated actions comprises automatically initiating performance of testing at least a portion of the one or more elements of the at least one web-based application user interface in accordance with the one or more generated testing recommendations.

18. The apparatus of claim 16, wherein determining one or more user activity-related commonalities comprises generating multiple user activity-related categories by processing the at least a portion of the one or more data structures using at least one hierarchical density-based spatial clustering of applications with noise (HDBSCAN) clustering algorithm.

19. The apparatus of claim 18, wherein generating multiple user activity-related categories comprises determining, within each of the multiple user activity-related categories, a breadth of unique users that utilize each of the one or more elements of the at least one web-based application user interface.

20. The apparatus of claim 19, wherein generating one or more testing recommendations comprises assigning a score to each of the one or more elements of the at least one web-based application user interface based at least in part on the determined breadth of unique users utilizing the element across at least a portion of the multiple user activity-related categories.
